(19) United States
(12) Patent Application Publication
(10) Pub. No.: US 2015/0379606 A1
(43) Pub. Date: Dec. 31, 2015

(54) SYSTEM AND METHOD TO PURCHASE PRODUCTS SEEN IN MULTIMEDIA CONTENT

(71) Applicant: Anand Vaidyanathan, Chennai (IN)

(72) Inventor: Anand Vaidyanathan, Chennai (IN)

(21) Appl. No.: 14/733,974

(22) Filed: Jun. 9, 2015

(30) Foreign Application Priority Data
Jun. 26, 2014 (IN) 3076/CHE/2014

(51) Int. Cl. G06Q 30/06; G06F 17/30

(52) U.S. Cl. CPC G06Q 30/0625; G06F 17/30044; G06Q 30/0633; G06F 17/30026

(57) ABSTRACT

A product purchase system that purchases a product seen in a multimedia content is provided. The product purchase system includes a database, a product selection module, a product identification module, and a purchase module. The database stores information related to (a) the product tagged in the multimedia content, and (b) a sound signature associated with the product. The product selection module allows a user to select a product that is shown in the multimedia content. The product identification module identifies the selected product based on a tag associated with the product. The product identification module includes a sound signature module that recognizes a sound signature at which the product appears in the multimedia content. The sound signature module identifies the product that is associated with the sound signature by accessing the database. The purchase module directs the user to websites to purchase the product when the product is identified.

### BACKGROUND

1. Technical Field

The embodiments herein generally relate to purchasing products electronically, and, more particularly, a system and method to purchase products seen in multimedia content.

2. Description of the Related Art

Traditional forms of marketing and advertisement have primarily relied on commercials. Thirty or sixty-second spots are strategically placed throughout programs. Through, the use of demographics and other well know marketing methods advertisements are shown during programs in hopes of attracting purchasers.

Movies, which lack the ability to stop and play a commercial, have bypassed the use of commercials through the use of product placements. Products are strategically placed in a movie or a show, often for a predetermined price, such that the viewers will notice the product and want to purchase it.

The problem that occurs is that absent blatant product placements that make the viewer aware of the product, its maker and where it may be purchased, product placement advertising is limited. Although, it may be applied to traditional television programs, its applicability is limited. Products that do not have immediate visual cues as to maker, name and model are not well suited for product placement use.

Accordingly, there remains a need for an unique system and method for creating a dynamic product placement database that can be accessed in real-time or on a delayed basis, and provides the viewer with key marketing information about a specific product.

### SUMMARY

In view of the foregoing, an embodiment herein provides a product purchase system that purchases a product seen in a multimedia content. The product purchase system includes a database, a product selection module, a product identification module, and a purchase module. The database stores information related to (a) the product tagged in the multimedia content, and (b) a sound signature associated with the product that is tagged. The product selection module allows a user to select a product that is shown in the multimedia content. The product identification module identifies the product based on a tag associated with the product. The product identification module further includes a sound signature module that recognizes a sound signature at which the product appears in the multimedia content. The sound signature module identifies the product that is associated with the sound signature by accessing the database. The purchase module directs the user to websites to purchase the product when the product is identified.

In one embodiment, the product purchase system further includes a screen shot recognition module, a product tracker module, and a time stamp module. The screen shot recognition module is configured to recognize the product shown in the multimedia content using a screenshot of the multimedia content at which the product appears. The product tracker module is configured to recognize the product shown in the multimedia content using the characteristics of the product. The time stamp module is configured to recognize the product shown in the multimedia content using a time stamp at which the product appears in the multimedia content. In another embodiment, the product purchase system further includes a product tagging module that tags the product seen in the multimedia content with at least one of (i) a sound signature of the multimedia content at which the product appears, (ii) a characteristic of the product (iii) a time stamp at which the product appears in the multimedia content, and (iv) a screen shot of the product.

In another aspect, a product purchase system that purchases a product seen in a multimedia content is provided. The product purchase system includes a database, a product selection module, a product identification module, and a purchase module. The database stores information related to (a) the product tagged in the multimedia content, and (b) a sound signature associated with the product that is tagged. The product selection module allows a user to select a product that is shown in the multimedia content. The product identification module identifies the product based on a tag associated with the product. The product identification module further includes a product tracker module, a time stamp module, and a screen shot recognition module. The product tracker module is configured to recognize the product shown in the multimedia content using the characteristics of the product. The time stamp module is configured to recognize the product shown in the multimedia content using a time stamp at which the product appears in the multimedia content. The screen shot recognition module is configured to recognize the product shown in the multimedia content using a screenshot of the multimedia content at which the product appears. The purchase module directs the user to websites to purchase the product when the product is identified.

In one embodiment, the product purchase system further includes a sound signature module that recognizes a sound signature at which the product appears in the multimedia content. The sound signature module further identifies the product that is associated with the sound signature by accessing the database.

In yet another aspect, a method of purchasing a product seen in a multimedia content using a product purchase system is provided. The method includes followings steps: (i) selecting, using product selection module, the product that is shown in the multimedia content; (ii) identifying, using product identification module, the product that is shown in the multimedia content based on a tag (e.g., a sound signature, etc.) associated with the product; and (iii) recognizing, using a sound signature module, a sound signature at which the product appears in the multimedia content. The sound signature module identifies the product that is associated with the sound signature by accessing the database. The method may include the step of (iv) directing, using purchase module, a user to e-commerce websites to purchase the product. The method may further include the steps of: (v) recognizing, using a product tracker module, the product that is shown in the multimedia content using the characteristics of said product; and (vi) recognizing, using a time stamp module, the product that is shown in the multimedia content using a time stamp at which the product appears in the multimedia content.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a user device to purchase a product seen in a multimedia content using a product purchase system according to an embodiment herein;

FIG. 2 illustrates an exploded view of the product purchase system of FIG. 1 that is used to purchase products seen in multimedia content according to an embodiment herein;

FIG. 3 is a flow diagram illustrating a method of purchasing products seen in the multimedia content using the product purchase system of FIG. 1 according to an embodiment herein;

FIGS. 4A and 4B illustrates an operation of placing a product in the multimedia content and purchasing the product that is shown in the multimedia content according to an embodiment herein; and

FIG. 5 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

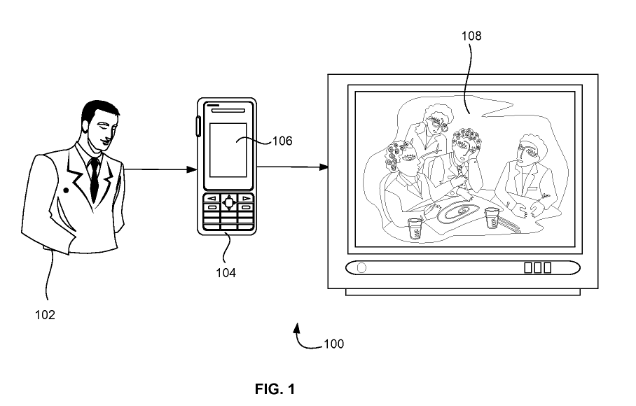

As mentioned, there remains a need for an unique system and method for creating a dynamic product placement database that can be accessed in real-time or on a delayed basis, and provides the viewer with key marketing information about a specific product. The embodiments herein achieve this by providing a product purchase system that provides a user interface to the user to select and purchase a product which is shown in a multimedia content. Referring now to the drawings, and more particularly to FIG. 1 through FIG. 5, where similar reference characters denote corresponding features consistently throughout the figures, there are shown preferred embodiments.

FIG. 1 illustrates a system view 100 of a user 102 communicating with a user device 104 to purchase a product seen in a multimedia content 108 using a product purchase system 106 according to an embodiment herein. The product purchase system 106 provides a user interface to the user 102 to select and purchase a product which is shown in the multimedia content 108 (e.g., a movie, a television ad, a magazine ad, and a tele-serial, or a live telecast of an event).

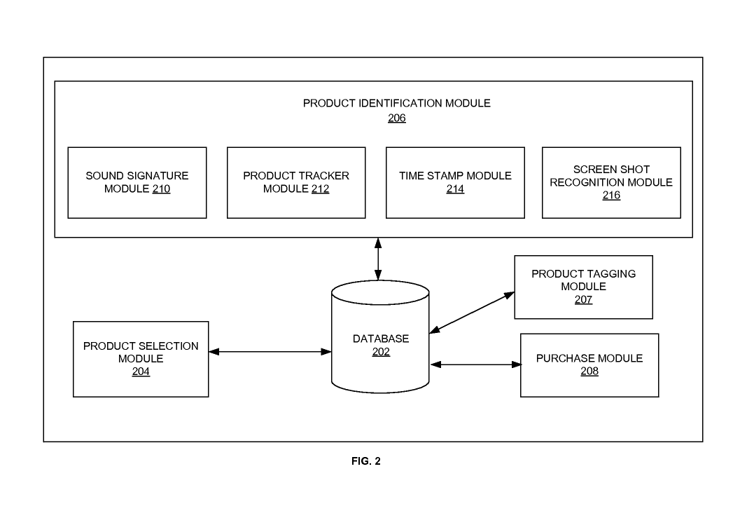

FIG. 2 illustrates an exploded view of the product purchase system 106 of FIG. 1 to purchase products seen in the multimedia content 108 according to an embodiment herein. The product purchase system 106 includes a database 202, a product selection module 204, a product identification module 206, a product tagging module 207, and a purchase module 208. The product selection module 204 is configured to allow a user to select a product seen in the multimedia content 108 (e.g., a movie, a television ad, a magazine ad, an e-magazine, a video magazine, a dynamic hoarding, a tele-serial, or a live telecast of an event). In one embodiment, the product may be a watch, a jacket, a phone, a laptop, jewelry, a dress, an even incidental item like crockery, a wall hanging, a furniture, a curtain, a bed sheet etc. The product selection module 204 allows the user 102 to select a product which is shown in the multimedia content 108 using the user device 104. The product identification module 206 is configured to identify the product that is shown in the multimedia content 108 using a tag of the selected product.

The product tagging module 207 is configured to tag a product that is shown in the multimedia content 108 (e.g., a movie, a television ad, a magazine ad, an e-magazine, a video magazine, a dynamic hoarding, a tele-serial, or a live telecast of an event). The product that is shown in the multimedia content 108 is tagged using at least one of (i) a sound signature of the multimedia content 108 at which the product appears, (ii) a characteristic of the product (iii) a time stamp at which the product appears in the multimedia content 108, and/or (iv) a screen shot of the product. The product tagged and the corresponding position is stored into the database 202 in a centralized server, and indexed with searchable parameters for easy retrieval.

In one embodiment, the product tagging module 207 tags a product seen in the multimedia content 108 with a sound signature of the multimedia content 108 at the microsecond when the product appears on the multimedia content 108. For example, a watch worn by a male protagonist that appears in a movie is a product tagged to the sound signature(s) that accompany the moment(s) that the product (i.e. the watch) appears in the movie. The product tagged and the corresponding sound signature is stored into the database 202 in a centralized server, and indexed with searchable parameters for easy retrieval. The products tagged are linked to the product available on e-commerce, or m-commerce websites. In one embodiment, the sound signature which corresponds to the multimedia content 108 is accessed by filtering out external noise of the sound signatures when the movie is being watched in a theatre, or a room. In another embodiment, the sound signature may have a series of subsequent and successive sound signatures that are associated with the product when the sound signature of the product is overlapping with sound signature of other products. In other words, in order to select a product that is shown in the multimedia content 108, the series of subsequent and successive sound signature is used to narrow down to the exact moment of the multimedia content 108 by comparing with the database 202.

The product identification module 206 further includes a sound signature module 210 that recognizes the sound signature of the product that is selected using the user device 104. When the user 102 selects a product that is shown in the multimedia content 108, the sound signature module 210 recognizes the sound signature by accessing the database 202, the multimedia content 108, and a particular moment in the multimedia content 108. By identifying the particular moment in the multimedia content 108, a product that is associated with the moment in the multimedia content 108 is identified by accessing a product tag associated with the sound signature. The subset of these products is stored in the favorites of the user 102 for purchase in future. In yet another embodiment, when a sound signature overlaps with a number of multimedia contents, the sound signature module 210 is intelligent enough to isolate the exact multimedia content 108 that the user 102 is watching by eliminating the unrelated multimedia contents by listening to the sound signatures beyond the moment at which the product appears.

The sound signature module 210 recognizes an audio file and matches the audio file with sound signatures in the database 202 using a process. The process includes a step of creating a spectrogram for each sound file with a frequency of sound on first axis, time on second axis and amplitude on third axis. From the spectrogram of the audio files, the markers of frequency having high amplitude are identified. From the identified markers, the markers that include more frequency points surrounding in a cluster is isolated. The isolated markers that include high amplitude and are surrounded by a number of frequency points are marked out as reference for identification. Using a marker as reference, one or more frequency pairs are created. The one or more frequency pairs include a marker as a first frequency and another frequency point in the cluster as a second frequency along with a time duration difference between their occurrences. A set of frequency pairs and their duration are bunched to form a sound signature. The frequency pairs contain 3 kinds of information (i.e. two frequencies of the frequency pairs are matched, and a time gap between the frequency pair). A number of such frequency pairs in a batching together forms a sound signature. The frequency pairs are used as a starting point in matching the audio files and indexed as sound signatures against the marker frequency. When an audio file to be identified is played, the frequencies corresponding to the highest amplitudes are identified to find the bunch of frequency pairs that forms a sound signature. Once the frequency pairs are found out, the audio file is compared with the sound signatures in the database 202 to get a match sound signature. This process of matching sound files with the sound signature is efficient and effective. This process can be done minimum computation power and maximum efficiency in quick time.

In one embodiment, the product identification module 206 further includes a product tracker module 212, a time stamp module 214, and a screen shot recognition module 216. The product tracker module 212 is configured to recognize a product that is shown in appropriate position of the multimedia content 108 using the characteristics of the product such as color, shape and dimensions. The product tracker module 212 recognizes the product in the multimedia content 108 (e.g., a movie, a television ad, a magazine ad, an e-magazine, a video magazine, a dynamic hoarding, a tele-serial, or a live telecast of an event) by tracking the appearance of the products across screenshots and the characteristics of the product. When the multimedia content 108 is played on the user device 104, the user 102 selects a product that is shown in the multimedia content 108 by clicking/touching the product. The product tracker module 212 recognizes the product that appears in the screenshots of the multimedia content 108, and directs the user 102 to exclusive e-commerce or m-commerce websites to purchase or browse the product.

The time stamp module 214 is configured to recognize a product which is shown in the multimedia content 108 using a time stamp at which the product appears in the multimedia content 108. When the user watches the multimedia content 108, the time stamp module 214 allows a user to select a time stamp of the multimedia content 108 to identify a product that is associated with the time stamp. In one embodiment, the moment when the user 102 touches a screen of the user device 104 (e.g., an ipad) while watching the multimedia content 108, the x-y axis coordinates and the timestamp of the moment are identified to retrieve the product that is tagged to the x-y coordinates, and the timestamp.

The screen shot recognition module 216 is configured to recognize a product which is shown in the multimedia content 108 using a screenshot of the multimedia content 108 at which the products appears. The screen shot recognition module 216 recognizes the product in the multimedia content 108 (e.g., a movie, a television ad, a magazine ad, an e-magazine, a video magazine, a dynamic hoarding, a tele-serial, or a live telecast of an event) by selecting/clicking the screenshot of the multimedia content 108 at which the products appears. The purchase module 208 is configured to direct the user 102 to e-commerce or m-commerce websites to purchase the product.

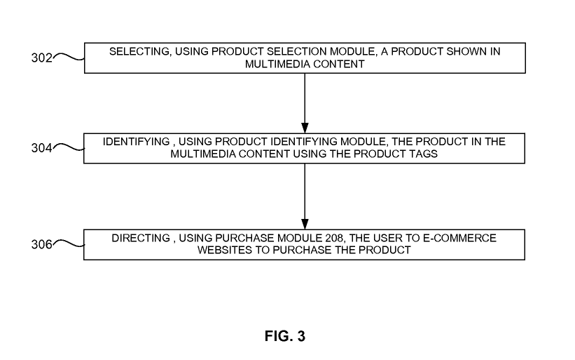

FIG. 3 is a flow diagram illustrating a method of purchasing a product that is shown seen in the multimedia content 108 of FIG. 1 according to an embodiment herein. In step 302, the user 102 selects a product that is shown in the multimedia content 108 (e.g., a movie, a television ad, a magazine ad, an e-magazine, a video magazine, a dynamic hoarding, a tele-serial, or a live telecast of an event) using the product selection module 204. In step 304, the product identification module 206 identifies the product seen in the multimedia content 108 using a tag of the product (e.g. a sound signature of the product, characteristics of the product, a screen shot of the product, a timestamp of a product). In step 306, the purchase module 208 directs the user 102 to e-commerce or m-commerce websites to purchase the identified product. The method further includes the step of tagging a product that is shown in the multimedia content 108 using at least one of (i) a sound signature of the multimedia content 108 at which the product appears, (ii) a characteristic of the product (iii) a time stamp at which the product appears in the multimedia content 108, and/or (iv) a screen shot of the product.

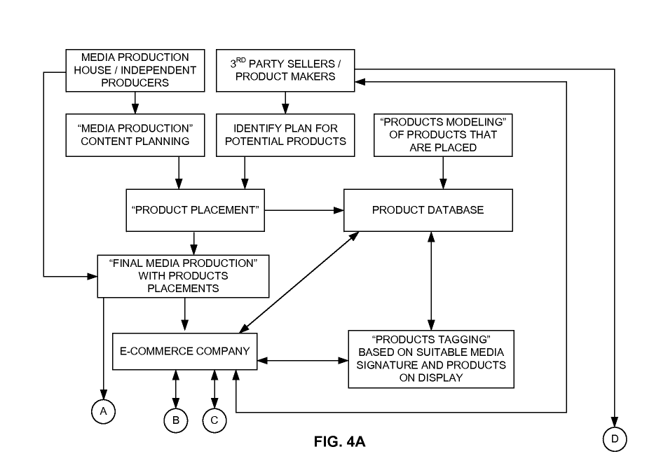

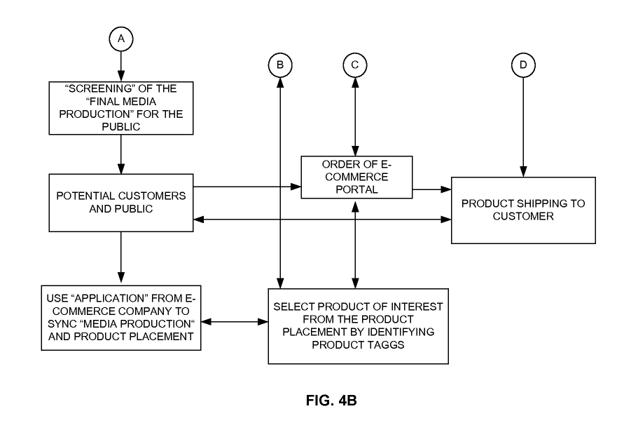

FIGS. 4A and 4B illustrates an operation of placing a product in the multimedia content 108 and purchasing the product that is shown in the multimedia content 108 according to an embodiment herein. A media production house includes the multimedia content 108 such as a movie, a serial, an internet content, a music video, a cookery show, a live broadcast, and an advertisement, etc. The planning for placing product on the multimedia content 108 is done in the media production house. In one embodiment, a product maker identifies a potential product for product placement on the multimedia content 108. The information about (a) a product that is placed, and (b) the product that is tagged using a sound signature are stored in the database 202 (e.g., a product database). The media production house produces the multimedia content 108 with product placement for screening the multimedia content 108 to the user 102 (e.g., potential customer, public, etc.). The multimedia content 108 with product placement includes information that directs the user 102 to the e-commerce or m-commerce website. In one embodiment, the database 202 is connected to an e-commerce or m-commerce company. The e-commerce or m-commerce company includes an application to (a) sync the multimedia content 108 and the product placement, and (b) select a product of interest from the product placement by identifying product tags. In one embodiment, the user 102 may order the product of interest through e-commerce or m-commerce website. In one embodiment, a third party seller/product maker is directly connected to the e-commerce or m-commerce website/company. Once the user 102 selected the product of interest, the e-commerce or m-commerce website directs the order to the third party seller/product maker. The third party seller/product maker ships the product of the interest to the user 102.

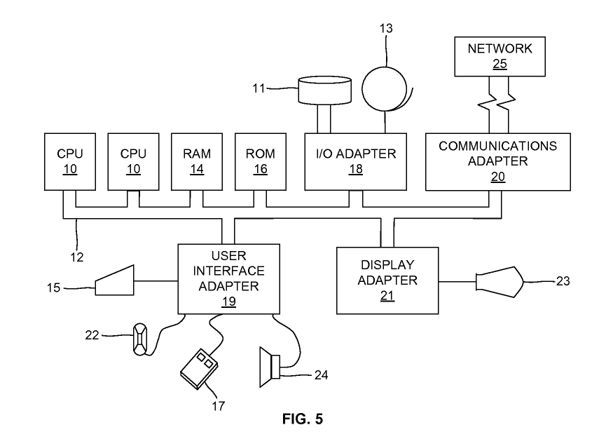

FIG. 5 illustrates a schematic diagram of a computer architecture used in accordance with the embodiments herein. The computer architecture includes one or more processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The computer architecture further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The product purchase system creates a dynamic product placement database that can be accessed in real-time or on a delayed basis. The product purchase system provides the user 102 with key marketing information about a specific product. The product purchase system provides a user interface to the user 102 to select and purchase a product which is shown in a multimedia content. The product purchase system converts the product placements into potential e-commerce sales.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A product purchase system that purchases a product seen in a multimedia content, wherein said system comprises:
a database that stores information related to (a) said product that is tagged in said multimedia content, and (b) sound signature associated with said product;
a product selection module that allows a user to select said product that is shown in said multimedia content;
a product identification module that identifies said product based on a tag associated with said product, wherein said product identification module comprises:
a sound signature module that recognizes a sound signature at which said product appears in said multimedia content, wherein said sound signature module identifies said product that is associated with said sound signature by accessing said database; and
a purchase module that directs said user to websites to purchase said product when said product is identified.

2. The product purchase system of claim 1, further comprises a screen shot recognition module that is configured to recognize said product that is shown in said multimedia content using a screenshot of said multimedia content at which said product appears.

3. The product purchase system of claim 1, further comprises a product tracker module that is configured to recognize said product that is shown in said multimedia content using the characteristics of said product.

4. The product purchase system of claim 1, further comprises a time stamp module that is configured to recognize said product that is shown in said multimedia content using a time stamp at which said product appears in said multimedia content.

5. The product purchase system of claim 1, further comprises a product tagging module that tags said product seen in said multimedia content with at least one of (i) a sound signature of said multimedia content at which said product appears, (ii) a characteristic of said product (iii) a time stamp at which said product appears in said multimedia content, and (iv) a screen shot of said product.

6. A product purchase system that purchases a product seen in a multimedia content, wherein said system comprises:
a database that stores information related to (a) said product that is tagged in said multimedia content, and (b) a sound signature associated with said product;
a product selection module that allows a user to select said product that is shown in said multimedia content;
a product identification module that identifies said product based on a tag associated with said product, wherein said product identification module comprises:
a product tracker module that is configured to recognize said product that is shown in said multimedia content using the characteristics of said product;
a time stamp module that is configured to recognize said product that is shown in said multimedia content using a time stamp at which said product appears in said multimedia content;
a screen shot recognition module that is configured to recognize said product that is shown in said multimedia content using a screenshot of said multimedia content at which said product appears; and
a purchase module that directs said user to websites to purchase said product when said product is identified.

7. The product purchase system of claim 6, wherein said product purchase system comprise a sound signature module that recognizes a sound signature at which said product appears in said multimedia content, wherein said sound signature module identifies said product that is associated with said sound signature by accessing said database.

8. A method of purchasing a product seen in a multimedia content using a product purchase system, said method comprising:
selecting, using product selection module, said product that is shown in said multimedia content;
identifying, using product identification module, said product in said multimedia content based on a tag associated with said product, wherein said tag is a sound signature associated with said product;
recognizing, using a sound signature module, a sound signature at which said product appears in said multimedia content, wherein said sound signature module identifies said product that is associated with said sound signature by accessing said database; and
directing, using purchase module, a user to e-commerce websites to purchase said product.

9. The method of claim 8, further comprising the step of recognizing, using a product tracker module, said product that is shown in said multimedia content using the characteristics of said product.

10. The method of claim 8, further comprising the step of recognizing, using a time stamp module, said product that is shown in said multimedia content using a time stamp at which said product appears in said multimedia content.
